(19) United States
(12) Patent Application Publication
(10) Pub. No.: US 2024/0193567 A1
(43) Pub. Date: Jun. 13, 2024

(54) Method for trading a digital asset

(71) Applicant: EGGTRONIC ENGINEERING SPA, MODENA (IT)

(72) Inventors: Andrea BETTATI, MODENA (IT); Gabriele LODI, MODENA (IT); Davide MALVEZZI, MODENA (IT); Alice ROVERSI, MODENA (IT); Igor SPINELLA, MODENA (IT)

(21) Appl. No.: 18/553,756

(22) PCT Filed: Apr. 8, 2022
(86) PCT No.: PCT/EP2022/059513

§ 371 Date: Oct. 3, 2023

(30) Foreign Application Priority Data
Apr. 8, 2021 (GB) 2105001.8

(51) Int. Cl. G06Q 20/12; H04L 9/00; H04L 9/30

(52) U.S. Cl. CPC G06Q 20/123; H04L 9/30; H04L 9/50

(57) ABSTRACT

There is provided a method, the method including the steps of: at a key generator subsystem: generating a public-private encryption key pair for a device, and transmitting the generated public key to be registered on a blockchain; at one or more processors: encrypting a digital asset via the public key of the device, and linking or associating the encrypted digital asset to a non-fungible token (NFT), in which the NFT is associated with a smart contract written on the blockchain; and at the device: requesting access to the NFT-linked digital asset; receiving the NFT-linked digital asset when the requirements of the smart contract are met; and decrypting the NFT-linked digital asset using the private key.

### BACKGROUND OF THE INVENTION

### 1. Field of the Invention

The field of the invention relates to a method for trading digital assets, and to related systems and apparatus.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### 2. Description of the Prior Art

The term ‘blockchain’ is typically used to refer to a distributed ledger that can facilitate the process of recording transactions and tracking assets in a network. Each transaction is recorded in a block and many transactions are effectively blocked together in an irreversible chain: the blockchain. Hence, transactions cannot be altered retroactively without the alteration of all blocks. Blockchains can be public, private, permissioned, or built by a consortium.

A blockchain can be implemented in a decentralised system, so that no single group or person has control, but instead all users collectively retain control. One advantage of decentralised blockchains is that third parties are completely removed from authorising transactions: no authority is needed for access and permission control as well as for transaction recording. Hence, a decentralised blockchain can provide increased robustness, safety and lower cost.

To automate the execution of the transaction of an asset on the blockchain, smart contracts can be used. Smart contracts are programs that exist on the blockchain and that enable automatic updating of the blockchain when predetermined conditions of a transaction are met.

An asset can be considered fungible or non-fungible. A fungible asset is interchangeable with another instance of the assets of the same kind. One example is money or cryptocurrency such as bitcoin; one bitcoin is the same as any other bitcoin and they can be traded or changed as equivalents.

Non-Fungible Tokens (NFT) on the other hand are unique and non-interchangeable, and therefore allow traceability of unique physical or non-physical assets. The intrinsic value of NFTs is also based on their scarcity. NFTs are run or controlled by smart contracts that regulate transactions for these digital assets and their authenticity on a linked blockchain, such as Ethereum, Binance, or Cardano.

The NFTs market is increasing due to the inherent differentiation of digital files: since the information stored in an NFT can be any content, as well as its author and the number of authorised unique copies. NFTs also cover a broad landscape of products, such as artworks, trading cards, digital lands, virtual furniture, fashion items, music, and video footages. However, while trading and collecting NFTs has recently boomed, so has the risk of digital theft. There is therefore a need for a more secure solution for trading these digital assets and/or for controlling both the number of authorised copies and their ownership.

Further, the hardware, such as ICs or any electronic systems, used to handle digital assets is often assumed to be reliable by default, against for example content theft or tampering.

However, the security of electronic systems may also be vulnerable to threats and attacks. As a result, the supply chain of electronic systems used to trade and download digital assets cannot be trusted.

There is also a need for an improved solution to protect all actors that are involved in trading digital assets, from the manufacturer of the hardware solution used to handle or download the digital assets to the authors of digital assets.

### SUMMARY OF THE INVENTION

An implementation of the invention is a computer implemented method including the steps of:
at a key generator subsystem: generating a public-private encryption key pair for a device, and transmitting the generated public key to be registered on a blockchain;
at one or more processors: encrypting a digital asset via the public key of the device, and linking or associating the encrypted digital asset to a non-fungible token (NFT), in which the NFT is associated with a smart contract written on the blockchain; and
at the device: requesting access to the NFT-linked digital asset; receiving the NFT-linked digital asset when the requirements of the smart contract are met; and decrypting the NFT-linked digital asset using the private key.

Another aspect of the invention is a method including the steps of:
at a key generator subsystem: generating a public-private encryption key pair for a device, and transmitting the generated public key to be registered on a blockchain;
at one or more processors: generating a symmetric key, encrypting a digital asset via the symmetric key, generating a hybrid key by encrypting the symmetric key using the public key of the device, and linking or associating the encrypted digital asset to a non-fungible token (NFT), in which the NFT is associated with a smart contract written on the blockchain; and
at the device: requesting access to the NFT-linked digital asset; receiving the NFT-linked digital asset and the hybrid key when the requirements of the smart contract are met; and decrypting the hybrid key using the private key and decrypting the NFT-linked digital asset using the symmetric key.

Another aspect of the invention is a system comprising:
a key generator subsystem, that is configured to generate a public-private encryption key pair for a device, and transmit the public key to be registered on a blockchain;
one or more processors configured to encrypt a digital asset via the public key of the device, and link or associate the encrypted digital asset to a non-fungible token (NFT), in which the NFT is associated with a smart contract written on the blockchain; the device, in which the device is further configured to: request access to the NFT-linked digital asset; receive the NFT-linked digital asset when the requirements of the smart contract are met; and decrypt the NFT-linked digital asset using its private key.

Another aspect of the invention is a system comprising:
a key generator subsystem, that is configured to generate a public-private encryption key pair, and transmit the public key to be registered on a blockchain;
one or more processors configured to generate a symmetric key, encrypt a digital asset using the symmetric key, generate a hybrid key by encrypting the symmetric key using the public key of the device, and link or associate the encrypted digital asset to a non-fungible token (NFT), in which the NFT is associated with a smart contract written on the blockchain;
the device, which the device is further configured to: request access to the NFT-linked digital asset; receive the NFT-linked digital asset and the hybrid key when the requirements of the smart contract are met; decrypt the hybrid key using the private key and decrypt the NFT-linked digital asset using the symmetric key.

Another aspect of the invention is a device for securely trading or downloading a digital asset, in which the device includes a key generator subsystem or is connected to a key generator subsystem that is configured to generate a public-private key pair, in which the public key is registered on a blockchain and the private key is stored on a non-transitory storage medium of the device, such that when the device requests a digital asset associated or linked to a smart contract on the blockchain, the digital asset is encrypted using the public key registered on the blockchain and the device is configured to receive the encrypted digital asset and to decrypt the digital asset using its private key.

Another aspect of the invention is a device for securely trading or downloading a digital asset, in which the device includes a key generator subsystem or is connected to a key generator subsystem that is configured to generate a public-private key pair, in which the public key is registered on a blockchain and the private key is stored on a non-transitory storage medium of the device, such that when the device requests a digital asset connected to a smart contract on the blockchain, the digital asset is encrypted using a symmetric key, and the device is configured to receive the encrypted digital asset and an hybrid key corresponding to the symmetric key encrypted using the public key of the device, to decrypt an hybrid key using its private key and to decrypt the digital asset using the symmetric key.

The invention is defined in the appended Claims.

The methods and systems described lead to many advantages:
Every transaction involving the digital asset and the device intended to receive the digital asset is recorded on a blockchain. Hence an end-to-end audit trail is recorded and stored, thereby protecting all the actors in the supply chain, from the device manufacturer to the digital content creator as well as the purchaser/owner of the digital content.
NFTs are used to represent the device intended to receive a digital asset. The digital asset can therefore be bound to their specific intended hardware.
A single integrated SoC solution is achieved, thus improving the overall security as no information can be leaked unless the access is explicitly granted by a backdoor. The use of additional hardware is therefore not needed, thereby also simplifying the number of hardware components needed and reducing the overall cost in the hardware solution.
The methods and systems provide an improved solution with higher level of protection against system intrusion and data theft. Data authentication is also improved.

### BRIEF DESCRIPTION OF THE FIGURES

Aspects of the invention will now be described, by way of example(s), with reference to the following Figures, which each show features of the invention:

FIG. 1 shows a block diagram of the architecture of a verified system on a chip (SoC).

FIG. 2 shows a workflow diagram summarising the steps for generating an NFT-linked artwork and downloading it on a digital frame.

FIG. 3 shows a workflow diagram summarising the steps for generating an NFT-linked firmware and downloading it on a microcontroller.

FIG. 4 shows a workflow diagram summarising the steps for generating an NFT-linked firmware and downloading it on a microcontroller, using two levels of encryption.

FIG. 5 shows a block diagram of the architecture of a verified system on a chip (SoC), where the firmware is stored in a decrypted form in a permanent storage medium.

FIG. 6 shows a block diagram with a further alternative architecture of the SoC.

FIG. 7 shows a workflow diagram illustrating the various steps of the design process of a microcontroller.

FIG. 8 shows the process of associating the main code with third-party libraries.

FIG. 9 shows a block diagram with a further alternative architecture of the SoC, in the case of third-party library inclusion.

### DETAILED DESCRIPTION

### 1. Motivation

Examples of problems associated with the transaction of digital assets are now described.

1.1 Protection of NFT-Based Digital Content from being Decrypted and Stolen

NFT-based digital content may keep their value specifically based on their intellectual property, which is compromised if, when decrypted, the digital content is intercepted and duplicated. This may happen for example during the transfer of a digital content from one device onto another.

A problem may therefore arise once the original digital content is reconstructed as it may be copied indefinitely, and its value may thus be destroyed. An example is when NFT-based artworks (e.g., pictures, music, or any other document redeemable with an NFT transaction) are shared between a phone or PC that has purchased the item and a connected digital device such as a monitor, a digital frame, or a Bluetooth speaker.

Once a digital asset is decrypted to be used on a physical device (i.e., the smartphone linked to the wallet which has purchased the digital asset), the digital asset may move outside of the device's memory and may be reproduced (i.e., converted into a visual information on a screen in case of an artwork). While in this form, the unencrypted stream of data (i.e., on a USB cable, an HDMI cable, a Bluetooth, or Wi-Fi connection) can be stolen and replicated for an indefinite number of times, with byte accuracy. Although the ownership of these unintended copies is not legitimated by the blockchain, the digital asset may still be traded and reproduced without control.

Moreover, the current NFT creation procedure is affected by inherent faults. As an example, once the digital content is produced and a reference blockchain is chosen, the original digital file/content is uploaded on a blockchain portal, where a dedicated software turns the digital asset into an encrypted asset associated with an NFT. This process of validating information, creating a new block, and recording that information into the blockchain may be referred to as “minting”.

The use of a blockchain portal also may represent a significant weakness, as the digital content is generally uploaded to the portal in a decrypted form and remains decrypted but “published”—thus exposed—while it lays on the portal waiting to be associated with the NFT token.

A solution is to strengthen the reference portal with additional software protections, such as by using an additional encrypted channel for digital file upload, in combination with a full open-source software granting for portal transparency. However, this system may remain weak and may be hacked and/or attacked using pharming techniques such as by redirecting traffic to another fake website.

### 1.2 Protection of Authorised Copies of Firmware Code to be Programmed on a SoC

A problem in the field of the protection of intellectual property often comes from the development and distribution of firmware and digital files. Once the digital file or firmware is developed, it is uploaded to a programmable integrated circuit, such as, microprocessors, microcontrollers.

The intellectual property may therefore be encrypted to avoid the source file being available. However, once the source file is decrypted to be loaded on an IC (Integrated Circuit) itself, it can be replicated an unlimited number of times into an indefinite number of devices. Furthermore, current systems also lack to record an audit trail for each transaction of the digital file. Hence, once a manufacturer receives a firmware from developers, the manufacturer can program as many microcontrollers, microprocessors, as possible, without any possibility of control.

Another problem relates to authorship attribution and the possibility of downloading unauthorised firmware code. A possible solution may be provided by connecting an additional device to the IC, which is used to verify that the firmware loaded has been authorised. The additional device may for example check relevant digital signatures that have been encrypted. The additional device may also send encrypted data to the IC. However, when the firmware code is in an unencrypted form in the IC, it may still be copied and transmitted externally to the IC. This solution therefore not only requires additional circuitry, thus extra cost, but also does not protect against unauthorised copies of the firmware code.

### 2. Overview of the Proposed System

### 2.1 Hardware-Centric Blockchain Trading Flow

A proposed solution is a full end-to-end trustless method for trading an NFT-linked digital asset. In particular, verified hardwares, such a System-on-a-Chip (SoC), ICs, microcontrollers, microprocessors or memories, have been specifically designed to generate, receive or transmit NFT-based digital assets.

Therefore, a secure flow of information is achieved by a hardware/software architecture which may provide the following:
That the original digital asset is never sent unencrypted in the clear to other devices or is never uploaded unencrypted on the internet.
Only verified hardware can download and decrypt the original digital asset.

In an example, the architecture makes use of the following building blocks:
A secure client interface software: an open-source, possibly decentralised, solution that regulates the hardware-centric trading connecting the various actors via a blockchain.
Verified hardware devices: Systems-on-Chip (SoCs), ICs, microcontrollers or microprocessors which can be associated with an NFT and therefore uniquely identified and tracked in a blockchain.

Together, the verified hardware and the secure client interface software enable the proper handling, manipulating and control of NFT-based encrypted digital content according to a specific flow of information exchange.

### 2.1.1 Involved Actors

There are several actors participating in the trading chain, each with a different role in the flow of information exchange:
Verified hardware device vendor/manufacturer/producer: we can consider as a single entity the one producing the SoC and the final product without loss of generality.
Digital asset author/creator: who creates and owns the IP of the traded digital content.
Final end-user or utiliser: the final person or service that buys a verified hardware device and handles the digital asset.

The verified device or verified SoC may therefore be equipped with a unique public/private key pair, where the public key has been registered or minted onto the blockchain by a verified vendor.

### 2.1.2 Verified Hardware

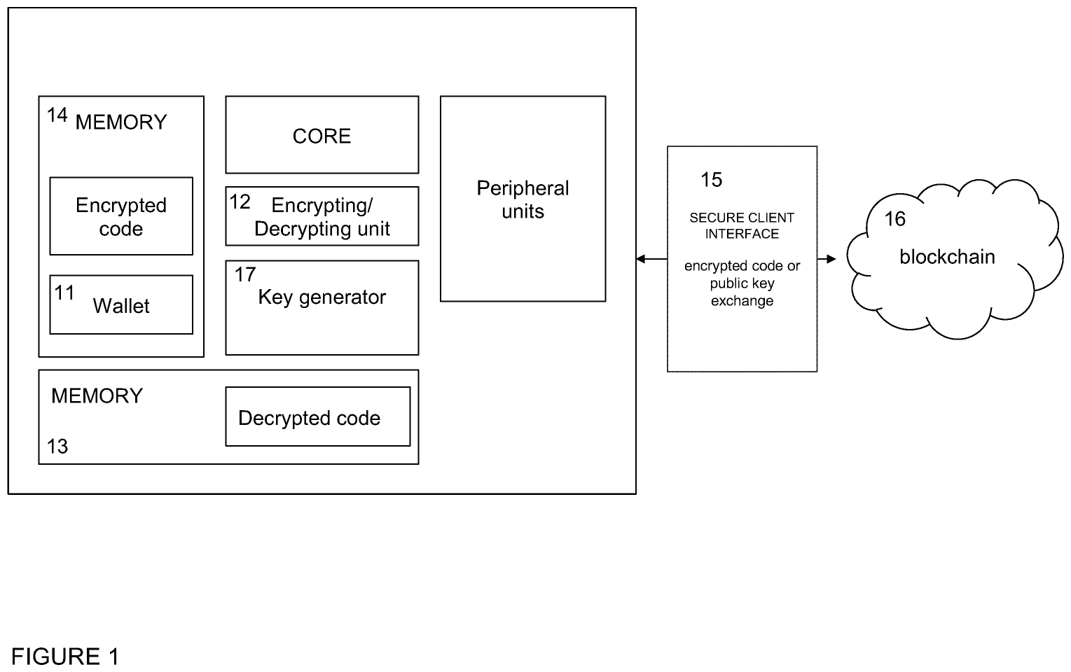

FIG. 1 shows a high-level overview of the architecture of a verified hardware, such as a System-on-a-Chip (SoC) that is configured to request and receive a digital asset when the requirements of the smart contract are met. The SoC comprises the following blocks: a key generator 17, an integrated digital wallet 11, an encrypting and decrypting unit 12, a first storage medium 13, and a second storage medium 14. The SoC is equipped with a connection to the blockchain, for example achieved via a secure client interface 15.

The connection to the blockchain may be achieved either on the verified hardware itself or via a connected hardware.

Advantageously, all the blocks may be integrated and confined within a single SoC. The SoC may have impassable barriers for any decrypted data flow. In an example, information leakage would only be possible if a hardware backdoor is intentionally added to the SoC itself. However, this risk is limited because each hardware that is intended to receive a digital asset is registered on the blockchain. Further, the identity of its creator may have therefore been verified.

As shown in FIG. 1, the SoC may comprise one or more of the following blocks or subsystems:
A key generator 17 that generates the private and public keys associated with the SoC hardware itself, based on different techniques, such as:
   combination of external seeds provided by the user: biometric signals, temperature, words, sounds or any other external source of seeds.
   internal seeds generator such as a random seed generator.
A digital wallet 11, i.e., a permanent and unchanging area of memory where the public and private keys are stored.
A decrypting unit 12: to access digital content encrypted with the SoC public key.
An encrypting unit 12: which can encrypt digital content stored inside the SoC. This may be done using the public key of a second verified device, to which the encrypted file can be safely sent.
A limited and specific region of the memory 13, containing the decrypted file.
A port or a network connection 15 to the blockchain portal 16, to allow the SoC to exchange encrypted code and public keys with external devices.

Generally, the hardware used in any of the methods or systems described below may integrate similar blocks or subsystems. In addition, the hardware does not have backdoors to access the code when it is in a decrypted form. This is made possible by relying on a blockchain to register the public key of the device.

Additionally, the public private key pair generated by the device is unique. Hence, when the device is registered on the blockchain, the blockchain is configured to verify that the public key has not already been previously registered on the blockchain. In that case, the blockchain may request that another public private key pair is generated by the new device. The blockchain may also alert the possible actors of the supply chain of a potential fraud/theft if the intended receiving hardware is not found on the blockchain itself.

Additionally, even the author of the digital asset may use a device that substantially includes the same blocks as shown in FIG. 1. Hence, the device used to create the digital asset may also be registered on the blockchain using the same methods described.

### 2.1.3 Secure Client Interface Software

The main interface between the different actors of the trading chain (the authors, the end-users and the device manufacturers or producers), the blockchain and the verified devices is referred to as a secure client interface. The secure client interface may be implemented by software, such as open-source, possibly decentralised, software. The secure client interface is a trusted component of the workflow provided for trading digital assets.

The secure client interface may enable the following:
to browse a blockchain, to search for:
   verified devices;
   verified devices producers;
   digital content NFTs: preview, metadata and associated digital wallet;
   hardware NFTs: preview, metadata and associated digital wallet.
authors/producers to register new content/devices.
end-users to request and/or buy NFTs.
authors to retrieve verified devices' public-keys and to encrypt digital assets.
verify that a public key is not already registered on the blockchain.

### 2.1.4 Automated Digital Content Encryption and Blockchain Registration

As an example, an author may receive hundreds of requests for multiple copies of a digital asset simultaneously. A scalable method for trading the multiple copies of the digital content may therefore use the secure client interface to support the authors by performing each step of the workflow automatically.

Hence, the system automatically retrieves requests related to digital assets, check that all the trading conditions are met for each request, retrieve the public keys of the corresponding devices, and encrypt the digital asset. Accordingly, a link to download the NFTs and any other useful information or metadata may be provided.

### 2.1.5 Workflow

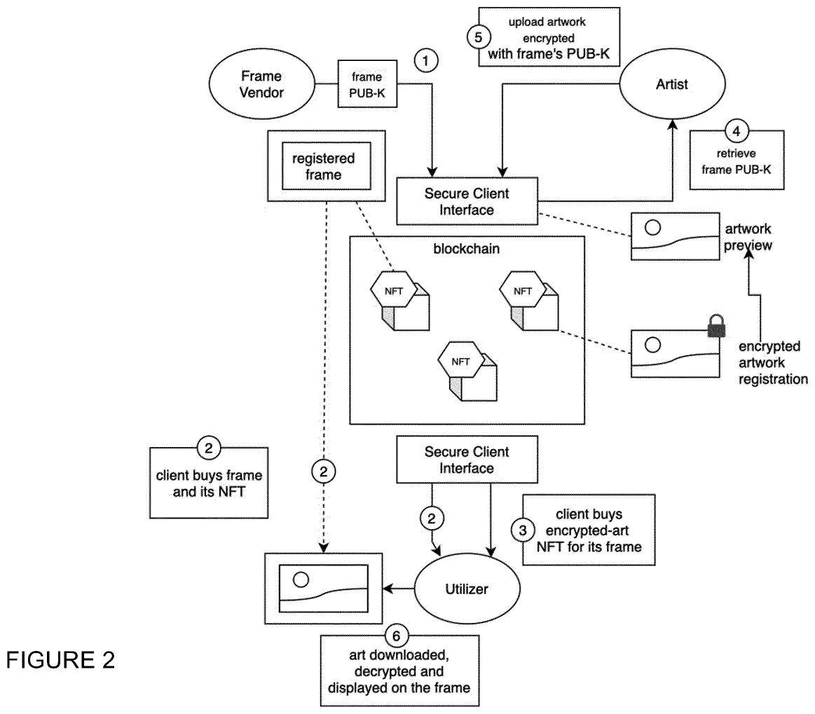

FIG. 2 provides a workflow diagram summarising the steps for trading a digital asset onto a verified hardware.

In the example shown in FIG. 2, the digital asset is an artwork, and the verified or receiving hardware is a digital frame (e.g., smart TV) that is configured to display the artwork. The workflow presented may generally be extended to the transaction and handling of any other digital assets, such as firmware, documents, messages, videos, music, or any other digital content.

FIG. 2 shows the following steps in the workflow:
Key Generation and Verified Hardware Registration 1
Hardware Trading 2
Digital Content Trading 3
Content Request by Verified Hardware 4
Encrypted Content Registration 5
Reception of Encrypted Content 6

Each step of the workflow shown in FIG. 2 is now described in more detail:

### Key Generation and Verified Hardware Registration

The digital frame is a verified hardware and includes the different subsystems as described earlier. The digital frame is therefore configured to manipulate the encrypted digital asset and is configured to be registered or “minted” on a blockchain.

The public key of the digital frame is registered on a blockchain and therefore becomes an asset token on the blockchain. Any event or transaction involving the registered digital frame may therefore be tracked on the blockchain. Other metadata, such as creation date or hardware version may also be added to the asset token corresponding to the digital frame. Additionally, the public key may be registered on the blockchain together with a digital signature, possibly of the digital frame producer.

As an example, at the first switching on or boot of the digital frame, such as at the end of a production chain, the key generator block may be configured to generate a public private encryption key pair. The public key of the digital frame is then registered on the blockchain by the frame producer.

Additionally, the digital wallet of the frame producer may be associated to its own digital signature, and hence identity. When registering the digital frame on a blockchain, the public key of the digital frame may be associated with the digital signature of the digital frame producer. As an example, this represents a further deterrent against registering a virtual, fake device, which would allow a malware user to access a decrypted code, knowing both the public and private keys. By making the producer signature publicly visible, the blockchain ensures a trustless secure way to avoid an attempt of fraud.

Hypothetically a malicious user may try to virtually replicate the asymmetric encryption system and provide the creator with a known or stolen public key. However, this would only be possible if the malicious hardware itself has been certified or verified and registered in the blockchain, together with a trusted producer signature. This scenario is extremely unlikely.

The connection to the blockchain may be directly available on the digital frame, via a network connection, or mediated by an external device.

### Hardware Trading

When the digital frame is sold to a user, it is therefore already registered on the blockchain and equipped with a unique digital identity to be used in the transactions of asset tokens. Hence, all the inputs and outputs of each transaction, along the entire supply chain, are processed and tracked on the blockchain via the use of smart contracts. This includes for example the purchase of the digital frame. The current owner of the digital frame may also always be known. Tracking may be performed in real time.

### Digital Content Trading

Independently from hardware trading, the creator of a digital asset to be traded may load a preview of the digital content on the NFT marketplace to be disclosed to possible buyers. The preview may contain only a portion of the digital asset. The artist or creator may also publish trading conditions for selling the digital asset on the blockchain via the use of a smart contract.

As an example, a transaction may be based on the exchange of a crypto token with another token or fungible cryptocurrency that has an economic value (an NFT from the creator, a corresponding cryptocurrency fee, or another token to prove the exchange from the receiver).

There are several possible trading conditions. One of the trading conditions is that the public key of the receiving hardware is published on the blockchain. The public key may also be associated with the digital signature of the hardware producer or manufacturer.

Trading conditions of the digital asset may also include one or more of the following:
list of currencies accepted for the transaction (i.e. another token or fungible cryptocurrency that has an economic value);
request that the utilizer's device is verified (as defined above);
any conditions on the transactions after the release of the encrypted digital asset:
request author's approval of subsequent transactions involving other subsequent users;
enable owners of the digital asset to send the digital asset to other verified devices.

A further trading condition specified within the smart contract may be number of receiving devices belonging to the same user that can reproduce the digital content at the same time: in this case, the fulfilment of the contract will be linked with the creation of several replicas of the digital content, as many as the required number of receiving devices, each one encrypted with the hardware-specific public key. In this case, the end-user requesting the digital asset may then share with the artist a collection of public keys, one for each device that is supposed to receive the digital asset.

The end-user may request the NFT through the Secure Client Interface. A transaction may begin with the smart contract providing the public key of the receiving hardware. The smart contract may then buffer the request and send a notification to the author of the digital asset. A list of requests may be transmitted to the author of the digital asset. Each request is verified by checking if the hardware from which the request has taken place has been verified and that the correct public key has been registered on the blockchain. Each request and verification step may be performed automatically by the Secure Client Interface.

Once the trading conditions are met, the digital asset may be encrypted with the public key of the receiving hardware and a message may be sent to the smart contract to validate the transaction. The author of the digital asset may also add his own signature to the artwork as a mark for its authenticity, and other useful metadata. NFT may also be associated with a download link for downloading the encrypted digital content. The download link may also include metadata such as a digital signature.

An improved method of encryption of the digital asset is therefore provided, as the encryption of the digital asset may be performed on the same device used for the digital asset creation, without relying on an external portal that accesses the decrypted file. The creator can thus rely on the blockchain portal for loading the digital asset when it is already in an encrypted, non-accessible form. The digital asset may therefore not exit the device of the creator in a decrypted form.

### Secure Digital Content Download

The end-user receives an event signalling the request has been fulfilled via the Secure Client Interface and can start a paid transaction with the smart contract to retrieve the corresponding digital-content-NFT.

The encrypted digital asset may then be sent to the receiver hardware, which is able to decrypt the NFT-based content since it is the depository of the private key associated with the encrypted digital asset.

The private key of the digital frame may always remain within the digital frame itself, for its entire life cycle, and may not be accessible to the end-user of the digital frame. Thus, the digital file may only be decrypted within the receiving device and not be manipulated, such as copied by the end-user of the receiving device.

The purchased digital asset may only be downloaded and reproduced on an intended receiving device. The decrypted digital stream of data associated with the digital asset may therefore not be sent from the receiving device to another device (i.e. cannot be decoded and sent to an external digital recorder).

A one-to-one correspondence may therefore be achieved between the encrypted digital file and the receiving hardware, so that neither the utilizer nor a different physical device can directly access and manipulate the decrypted information.

### 2.1.6 Trading of Digital Asset Between Devices

The above steps may also apply when the digital asset needs to be reproduced, and hence transferred to, another specific hardware.

As an example, when an artwork needs to be moved from a first digital frame to a second digital frame, the artwork is transferred again in an encrypted form, and the transaction is tracked via a smart contract published on the blockchain. The request of the second digital frame to receive the digital content may be managed by the Secure Client Interface.

The first digital frame relies on its own encryption unit, integrated in the SoC as described above, to encrypt the digital content with the public key of the second digital frame, registered on the blockchain, then sends the encrypted digital content. When the encrypted file is received by the second digital frame, it is decrypted based on its own private key.

This allows to keep the number of replicas of the artwork under control, hence to preserve the intrinsic value of the NFT-based digital content, based on scarcity, even if the user wants to reproduce the digital content on different devices (possibly, even more than one at time, if it is allowed by the smart contract stated by the author of the digital content). Hence, every device intended for NFT-based content reproduction needs to be equipped with a verified hardware.

Thus, a full ecosystem of certified devices is built up: the digital content, after the creation of the corresponding NFT, is kept safe during all transactions since every device may be equipped with the right hardware to handle encrypted digital files and to communicate with the blockchain.

In general, there are several use case applications which can implement the proposed solution for trading digital assets. Overall, the following issues of trading digital content may be addressed: unauthorised copies or distribution, fake contents, false date or time, false authorship. Indeed, the usage of the proposed hardware or SoC in every device can ensure an end-to-end secure way to exchange information, without the need of a trusted third party, and without the need of sending unencrypted information to third-party external portals or software. Because the approach may also rely on a single SoC solution, the use of additional hardware is not needed.

We now provide additional use cases in which the digital asset is a firmware code. However, the methods or systems described below may generally be applied to any type of digital asset.

### 2.2 Use-Case: Microcontroller Firmware Flash

When a hardware-software system is produced, a large volume of hardware units may need to be programmed with a specific software, commonly called firmware in the case of embedded systems. Typically, this may be offloaded to one or more third-party services, in charge of programming all the hardware units. During this operation the firmware IP could be copied and re-distributed, without the original author even knowing it.

The system described can address this critical step in the electronics production chain by ensuring that any distributed copy of the firmware is tracked in the blockchain.

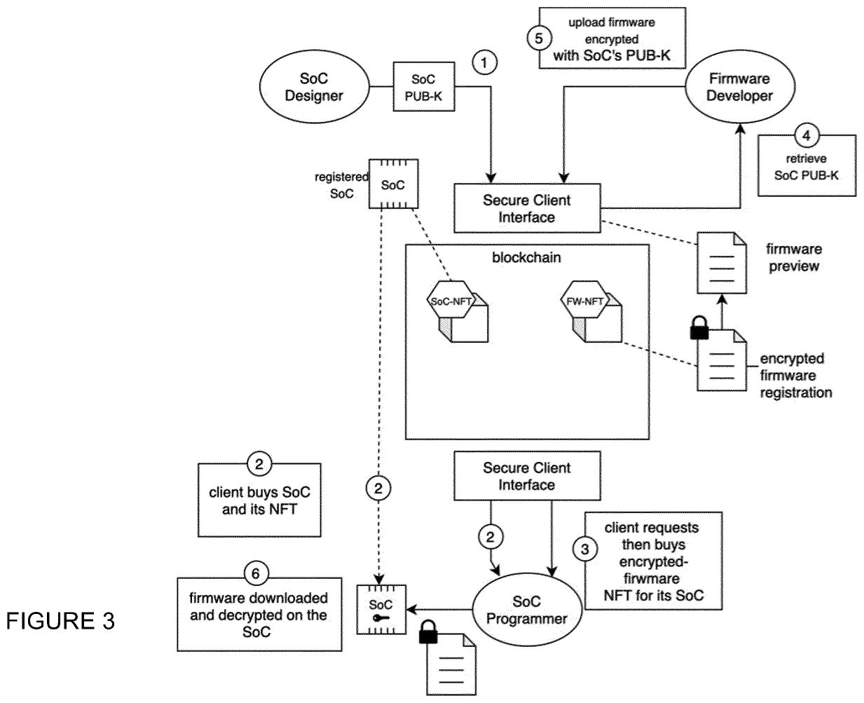

FIG. 3 provides another workflow diagram summarising the steps for generating an NFT-linked digital asset and downloading it on a verified hardware. In the example shown in the figure, the NFT-linked digital asset is a firmware code intended for a microcontroller. The hardware may be implemented as a microcontroller, which may be integrated on a PCB of an electronic device. The company that sells the electronic product may also be different from the one that programs the microcontroller. In addition, the firmware designer may also be different from the hardware designer.

The hardware, such as the SoC itself or more specifically the microcontroller, is designed and fabricated according to the basic building blocks of FIG. 1, without the addition of backdoors providing a path for the decrypted code to reach outside the SoC itself. When the SoC is turned on at the production site, its internal key generator generates the hardware-specific public and private keys and transmits the public key to be registered on the blockchain together with the digital signature of both the hardware designer and the production foundry, relying on a Secure Client Interface (possibly, open source and decentralised).

Each transaction involving the SoC may therefore be tracked on the blockchain, so that the current owner of the SoC is known.

In parallel, the firmware developer publishes on an online catalogue a preview of its code (including for example the main functionalities attained by the code itself) and the smart contract to satisfy in order to trade the firmware. The smart contract specifies several trading conditions, such as the maximum number of copies allowed for the specific firmware. The smart contract may also specify that public keys of the SOCs requesting the firmware are registered on the blockchain.

Once all the trading conditions are met, the firmware developer may encrypt each copy of the firmware with the hardware-specific public key through a Secure Client Interface. The firmware developer may also upload the corresponding download links.

The SoC utilizer or programmer receives the encrypted digital file and flashes the authorised copy on the assigned hardware. Each firmware copy is then decrypted on the corresponding SoC, using the hardware-specific private key.

As a result, the creator of the Intellectual Property (i.e. the firmware) does not need to trust the SoC programmer in replicating the digital files for a finite number of times. Instead, the encrypted version of the firmware is generated on the device of the firmware creator, using the public key specific of an intended SoC, and stays encrypted until it is received by the intended SoC itself. Advantageously, the number of authorised copies of the firmware can be controlled as it has been decided a priori, in the smart contract, by the firmware creator.

This may be sustained even without the need of third parties granting for the effective number of firmware replicas, nor the usage of additional hardware.

### 3. Hybrid Cryptographic System

The interface used for downloading the encrypted digital asset into the hardware device needs to be fast and as secure as possible. A solution is achieved by implementing an hybrid cryptographic system which combines asymmetric and symmetric cryptography.

In fact, streaming data through an asymmetric link like RSA or ECC may be costly in terms of computing resources. This is because implementing the SoC flashing procedure using only asymmetric-key encryption may require that the encrypted digital asset is downloaded on an internal memory, and then decrypted using a dedicated asymmetric-key decryption hardware. While this may be feasible, it would significantly increase the programming time of each SoC.

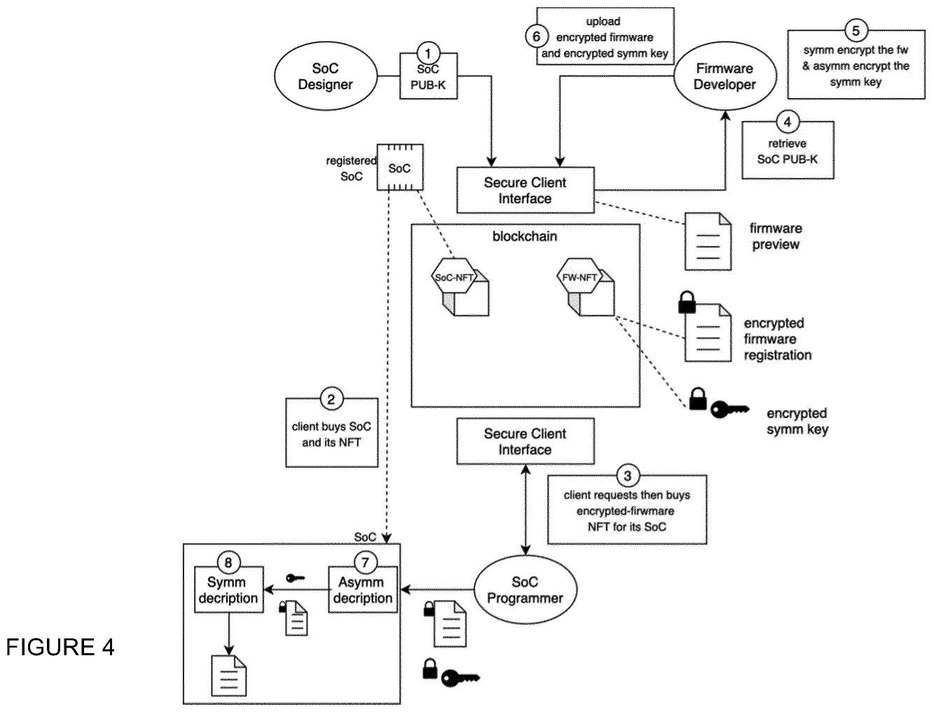

The extra symmetric decryption hardware block may be added in conjunction with the asymmetric one. A possible high-level flow of encrypted information is represented in FIG. 4. As compared with the workflow of FIG. 3, the public key is now used in a different way. As described in the following paragraph, the system also makes use of a more sophisticated hybrid key.

With the proposed flow, the hybrid key may be built as follows: the original digital asset is encrypted by the digital asset designer via a symmetric key, then this symmetric key is encrypted via the asymmetric, public key of the receiving hardware (that has been previously registered on the blockchain). The encrypted symmetric key is referred to as the hybrid key.

When the conditions of the smart contract are met, the receiving device receives 1) the encrypted symmetric key (i.e. the hybrid key) and 2) the digital asset code encrypted with the symmetric key.

The symmetric key is therefore not visible but encrypted with the public-key of the receiving, verified, device. The digital asset is therefore not accessible by devices other than the one intended for receiving the digital asset.

After the decryption of the hybrid key via the private key of the receiving verified device, the device may contain both the symmetrically encrypted digital asset code and the corresponding symmetric key for decrypting the digital asset code. The stage at which the digital asset code is available in a decrypted form can be tailored according to the specific architecture.

The combination of the hybrid cryptographic system (that in principle is compatible with several communication systems) with the blockchain principle allows to improve the safety of the system, as all the interactions are publicly tracked on the blockchain itself, allowing to verify the ownership of both the hardware and the digital asset.

The main blocks or subsystems of the hybrid cryptographic hardware are now described.

### Keys Generation

A block (keygen) is devoted to the automatic generation of a pair of immutable public-private keys, at the first start-up of the SoC as described earlier. The encryption keys may be used for the asymmetric encryption part may be based on asymmetric encryption algorithms such as Rivest-Shamir-Adleman (RSA) or Elliptic-Curve Cryptography (ECC). To generate the keys a True-Random-Number-Generator (TRNG) is used, while no external entropy data needs to be provided to guarantee the TRNG safety. The usage of a TRNG, typically transducing seeds from a physical phenomenon into keys, is achieved because generated keys have no correlation. Instead, for deterministic algorithms, such as Pseudo-Random Number Generator (PRNG) algorithms, there is a correspondence between the input and the output of the algorithm itself, hence predictability.

Both keys may be saved in an unmodifiable memory such as a One-Time-Programmable memory (OTP, since they uniquely identify the SoC hardware and are created only once. The public key can be sent to the external world via a programming interface (like the JTAG port), while the private key is kept secret. The protection of the private key is guaranteed by design as the verified hardware does not offer paths from the region where the private key is stored towards external communication ports. The only path allowed is towards the asymmetric decryption unit.

### Storing the Digital Content in the Verified Device

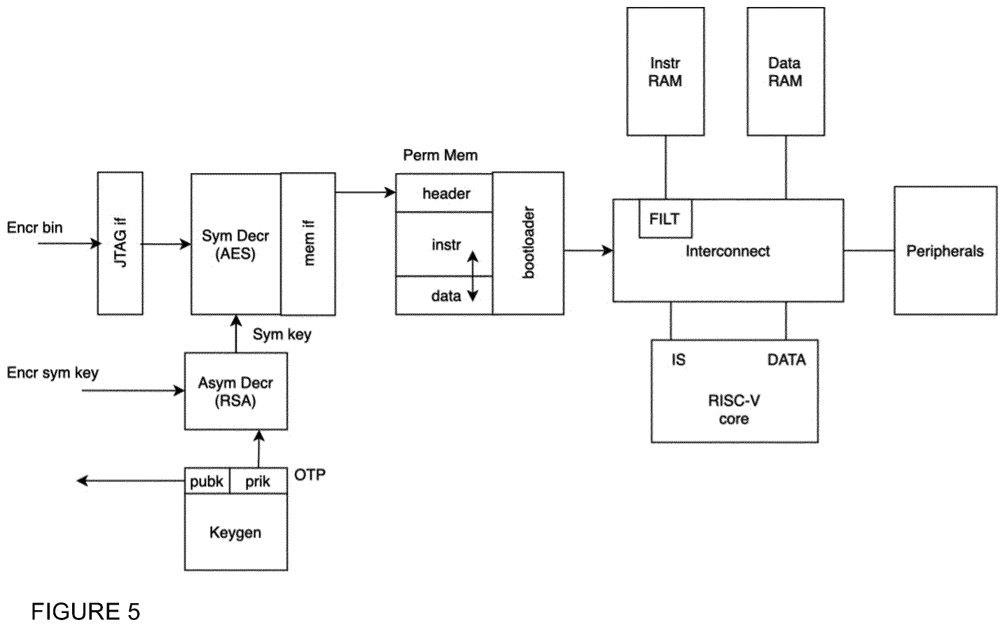

FIG. 5 provides the details of a possible hardware implementation, where the digital asset is stored in a decrypted form in a permanent memory. In this example, the digital asset is a firmware code. The firmware is divided into three main sections 1) header, 2) instruction and 3) data inside one or more of the following: the SoC EEPROM, Flash, OTP or any other kind of permanent memory integrated inside the SoC. The header may contain labels to define the location of both instructions and data inside the binary.

A bootloader may be in charge of loading the code in an execution memory (RAM), at each SoC startup.

The proposed architecture may contain many other blocks as found in typical SoC architectures, such as but not limited to: ADC, DACs, Op. AMPs, clock generator or any other functional blocks.

### Interface to the Verified Device

As shown in FIG. 5, a programming interface (JTAG if) may be used to receive the encrypted firmware and/or the hybrid key. The encrypted firmware and hybrid key may also be received using separate interfaces.

A decryption block (Asym Decr) handles messages asymmetrically encrypted using the SoC private key. In particular, the message may consist of the encrypted symmetric key used by the firmware author to encrypt the firmware code itself (i.e. the hybrid key).

An additional decryption unit (Sym Decr) is used to implement symmetric decryption algorithms, such as Advanced Encryption Standard (AES), Triple Data Encryption Algorithm (3DES) or threefish ones, which are applied to the encrypted code coming from the author.

Additionally, the maximum number of bytes that may be encrypted at once via a symmetric algorithm may be longer than the maximum number of bytes encrypted with an asymmetric algorithm. This may also depend on the algorithm used. As a result, if the length of the firmware code exceeds that number, it must be cut into many chunks, each one separately encrypted. The packet of all the encrypted chunks may be sent by the firmware author at the same time, while the loading on the SoC may be achieved one encrypted chunk at a time. Each chunk of firmware code may be decrypted and sent to a permanent memory (EEPROM), where it may be saved in a decrypted form.

A configurable bootloader, for example implemented as an hardware finite state machine in the case of a microcontroller, may be used to load the firmware code, arranged into instruction and data bytes, from the corresponding memory sections to the correct RAM banks at the SoC startup. The bootloader configuration itself may be stored in a specific section of the firmware code, for instance as a part of the header, and can be read by the bootloader to differentiate between data and instruction code regions in the memory.

The RAM may also be arranged into two separated banks, one for the instruction and one for the data, in order to guarantee that the instruction RAM, the one with the most valuable content, is only accessible by the instruction port of the processor's core, thus further preventing some access to try to steal the decrypted firmware.

An alternative architecture may also not use a dedicated instruction RAM, again with just reading access, and execute the firmware directly from a permanent memory. This change would lead to a lower area footprint, but the execution speed may be limited by the permanent memory timing.

An interconnection block (interconnect), composed by differentiated bus lines, allows and regulates the information exchange between the bootloader, execution memory, processor core and peripherals. In particular, it may implement an hardware filtering access (filt) that prevents blocks other than the core's instruction port and bootloader from accessing the instruction RAM during firmware execution, as it contains the most valuable part of the code, in a decrypted form.

This represents an additional protection against third-party sections included in the firmware that may be able to read the whole firmware while unencrypted and leak it.

The decrypted firmware may also be stored inside a permanent memory that is prevented from read instructions from external locations, such as external peripherals.

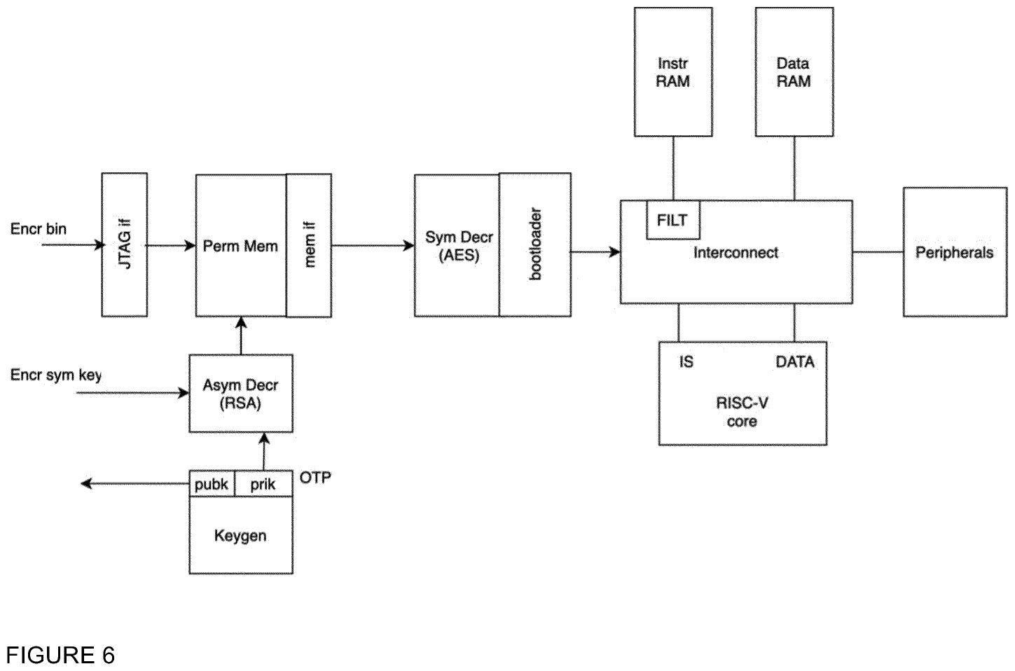

FIG. 6 provides a further alternative architecture of the SoC. The whole packet of encrypted firmware code may be stored directly into a permanent memory with each chunk of firmware code decrypted and loaded on the RAM on-the-fly. This may be done for example at the SoC start up. This allows for the firmware code to only be in a decrypted form during the execution stage by making use of a temporary memory storage.

Advantageously, the blocks manipulating the unencrypted firmware code are integrated on a single SoC. This further provides protection against intrusion and sniffing of the firmware code. For stealing the code, the SoC would have to be partially disassembled, while running, a sniffing technique should be applied to the miniaturised connection lines of the SoC. The enclosure and the compactness of the SoC design as a single chip improves security.

Outside of the SoC, the firmware code can only be exchanged in an encrypted form.

Moreover, the verified hardware may further include the ability to track all the movements of the unencrypted firmware starting from when it is first decrypted until it is encrypted again and transmitted externally to the IC. The tracking may be performed at the input/output data ports of each hardware block of the IC that interacts with the unencrypted firmware code; each port may check a specific ID pattern univocally corresponding to the firmware code, generated at the time of decryption. This list of movements can be maintained inside an on-chip ledger stored in a permanent memory and then be uploaded on the blockchain. This tracking system provides a further deterrent to steal the unencrypted bitstream by inserting untrusted malware hardware within the on-chip interconnections.

We now describe further improvements or modifications of the above methods.

4. Further Improved Security with a Verified EDA Suite

Potential leakages in the IC architecture may be introduced to access the encrypted code by an actor in the supply chain. The author of a digital asset may also be unaware of such leakage. A possible solution to the mentioned problem is the development of a Verified Electronic Design Automation (EDA) Suite. The Verified EDA suite may be provided as an open-source software and decentralised on a blockchain.

In that case, if a verified device producer wants to design a new, verified device, it is forced to use the Verified EDA suite. This trusted suite may connect to the blockchain via the Secure Client Interface, enabling the tracking of the design progression while keeping the source code (i.e. the IP) private.

### 5. Decentralised Verification

A possible way of verifying the hardware during the design process is to have multiple checks done at each milestone. As an example, moving from one step to another (e.g. from RTL to Synthesis) may be allowed when the previous step has been verified. The verification may happen in a decentralised environment (such as on a dApp, decentralised Application), where the design is tested against potential backdoors. A testbench may be engineered by a trusted actor that is different from the IC designer.

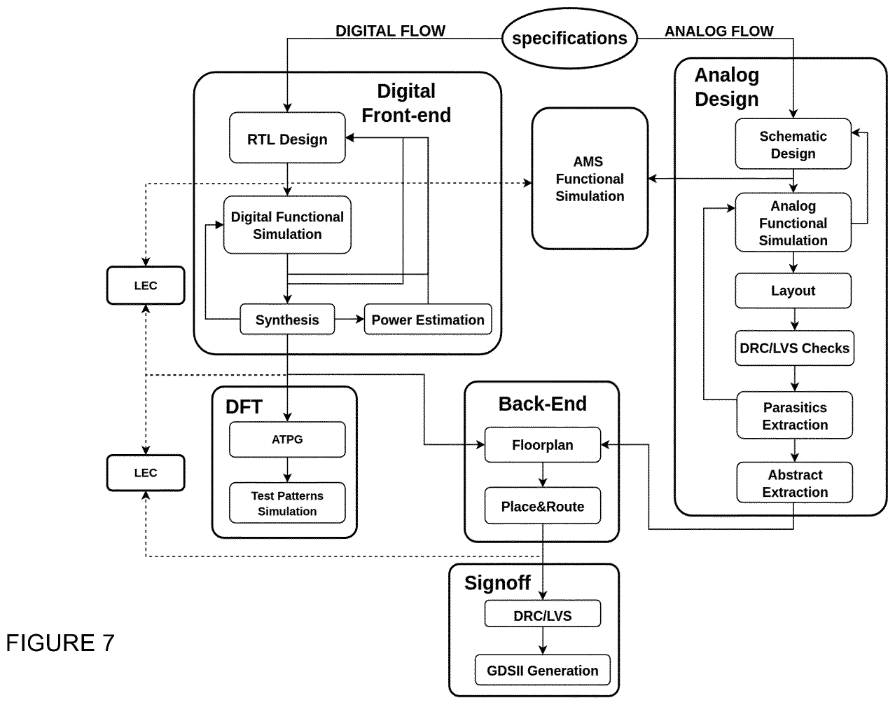

FIG. 7 shows a block flow diagram illustrating the various steps of the design process. Every step of the design process (RTL Freeze, Synthesis, Place&Route, etc.) may be associated with the creation of an NFT and/or its dApp-based verification. A record containing the most relevant data about the validated design file may be added on the blockchain. These records may be added as metadata to the NFT and may contain for example: the design tools used, the design version and the author's signature, progressively building up a complete audit trail of the design process.

The decentralised verification concept may also be applied directly to the silicon production side by having the programming tools of the processing machines forced to produce an end-of-test log verifiable by a dApp. The associated metadata may contain the machine ID as well as the signature of the manufacturing company owning the machine. As a result, at the end of the production of a batch of ICs with a defined design, the associated NFT may contain the most relevant information about their design, fabrication and testing.

Finally, the Automated Test Equipment (ATE) which powers up the IC for the first time may have access to the design and production information and store the information as metadata on a dedicated one-time programmable memory (OTP) on the IC. When the IC is switched on, an on-board permanent memory may already contain the relevant design-related metadata about the IC hardware. The unique public/private key pair may also be added as metadata.

To track off-chain data related to each IC, oracles may also be used. Oracles are decentralised softwares designed to gather real-world data and to deliver them on the blockchain. Production or post-production related data, such as manufacturing checkpoints, test results or logistics movements can therefore be tracked on the blockchain through oracles. These external data may therefore be presented in a tamper-proof and immutable way.

### 6. Third-Party Firmware Developers

Real-world firmware applications often rely on third-party libraries, which may be intellectual property of the third-party developer and as such are also intended to be encrypted and distributed in a controlled number of copies.

A verified compiler on the library developer side may arrange the library content into binary-format blocks such that every block contains just one function. Each block is encrypted separately, so it needs to be multiple of the chunk size processable by the encryption algorithm (i.e. 128-bit long for AES encryption). As an effect, each function will be either padded to the closest integer multiple of block-size bits by means of no-op instructions. The libraries are made available by their developer in an encrypted form, using the public key of the verified device.

Together with the library, the verified compiler will output an index file listing the correspondence between each block and the containing function.

A verified compiler on the firmware author side provides object files of the main code encrypted with the public key of the final receiving devices. A set of linker scripts drives the linker operations. The linker joins the encrypted object file with the used functions from the libraries: it resolves inter-module symbol references using the provided library index. A set of encrypted executable files originates and will be finally loaded on the receiving device.

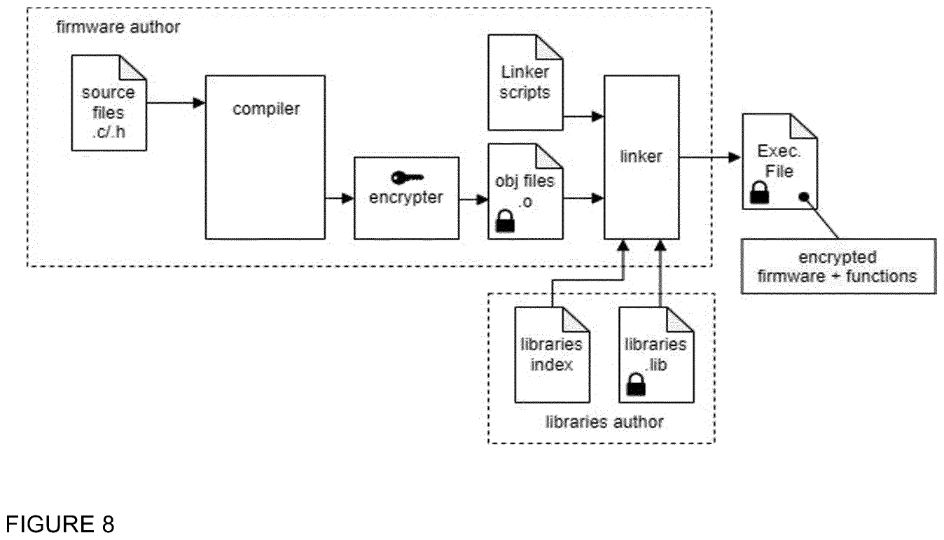

This index file will be then used by a linker at the firmware developer side, which will link the encrypted libraries and the encrypted firmware which utilises them. FIG. 8 shows how the firmware, and the used third-party libraries are linked to produce the set of encrypted executable files.

The metadata associated with the NFT of the main code may include the requested libraries to have the firmware code working, as well as their author signature. The addition of the signature can represent a deterrent for malware libraries, which may for instance have disruptive effects on the code or try to divert the decrypted code outside the SoC, as the usage of a specific library within a code is recorded on the blockchain.

When the utilizer or SoC programmer purchases the main code, it also purchases the associated libraries or functions (fcts), and receives the whole packet, compiled by the firmware developer, and encrypted with the same hybrid key, so that they can only be decrypted on the receiving hardware.

To compile the firmware for a specific verified device, the firmware designer may use a verified linker provided within the Secure Client Interface. The firmware developer may only select the blocks of the library of interest to have the main code running, while keeping all the files encrypted. Only the selected blocks are included in the final binary: the library's blocks are decrypted as well. Once uploaded on the verified device, the entire firmware (including the libraries) is stored in specific memory sections, according to their data or instruction content.

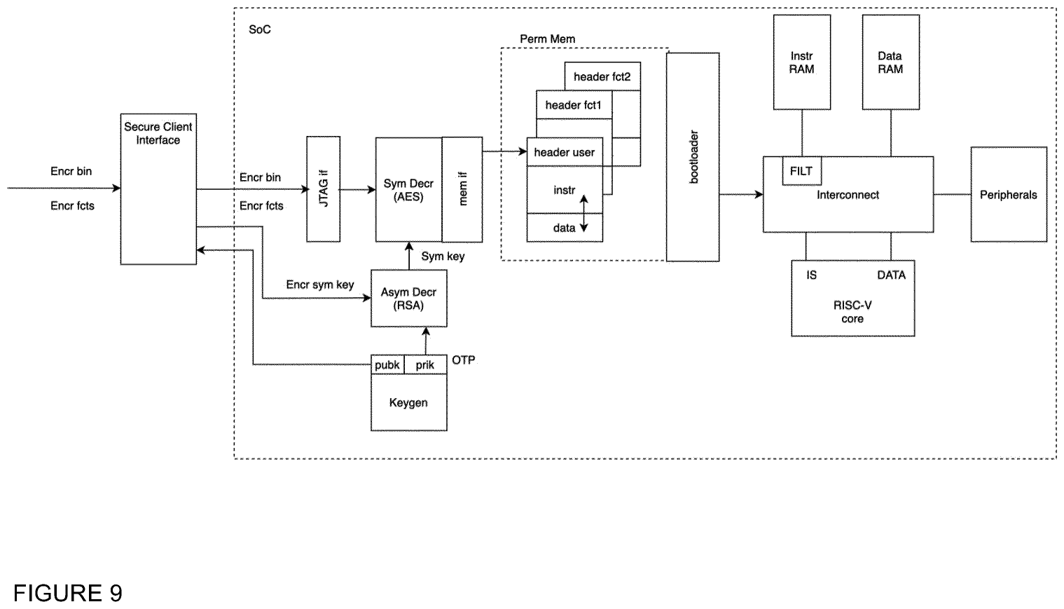

A block diagram of the architecture of the SoC is shown in FIG. 9.

### 7. Multiple Firmware Loading on the Same Hardware

According to the proposed architecture, the SoC can be reprogrammed, however it is advisable to completely reset the permanent, rewritable memory every time a new firmware is loaded, as an additional protection against malware code that, if added to the existing one, may have disruptive effects.

This is also consistent with the fact that each firmware version, with the associated libraries, is seen as a whole, associated to a specific hardware, and every time a hardware receives a firmware it is recorded on the blockchain.

### 8. Decryption of Firmware Code Based on a Large Statistic of Encrypted Code

If the number of replicas of the same code is sufficiently high, the decrypted version may be retrieved based on a large statistic of encrypted code.

To avoid this, some noise may be added each time an encrypted copy of the code is generated, so that copies are less correlated with one another and the statistics needed for reconstructing the source code are much larger.

9. Third-Party Software Handling the Decrypted Digital Content May have Backdoors

The third-party software that is used by the author to create the digital content may contain backdoors to steal the digital content itself while it is still in a decrypted form.

A possible deterrent is to have the data of the third-party software, including developer signature, software version and data of usage, recorded in the blockchain together with the corresponding NFT.

10. Decentralised Integrated Development Environment (dIDE)

The Integrated Development Environment used for the development of the main code as well as of the libraries may itself be decentralised (dIDE).

The code is developed inside the dIDE. then it is registered on the blockchain as an asset token, such as an NFT through the dIDE itself. We now provide two different use case scenarios.

In an open-source framework, anyone using a verified dIDE can access the code by providing an award such as paying a fee to its author through established smart contracts. The code is then usable and editable by another contributor also using the dIDE. Advantageously, the IDE may not allow the export of copies of the code outside of the dIDE. Then, an additional contributor may update or revise the code and also be rewarded for its contribution.

Instead, in case of a proprietary code, the code may still be developed inside the dIDE and in addition, it may also be registered as an asset token on a blockchain, such as an encrypted NFT. The code may thus still be used and traded and the number of copies of the code may be controlled by means of a smart contract, recognising royalties to the NFT owner.

Similarly to the decentralised EDA suite, a source code uploaded to the blockchain may also be compiled using a decentralised tool (we may refer to it as a decentralised compiler or dCompiler), thereby guaranteeing that the executable firmware code originates from a public or trusted (in case it is proprietary) source, without the addition of backdoors to alter its functionality.

### Appendix: Key Features

The key features are now generalised. We also list various optional sub-features for each feature. Note that any feature can be combined with one or more other features, including all the features or sub-features. No single feature is mandatory.

### A. Trustless Method for Downloading a Digital Asset at a Verified Device

A computer-implemented method, the method including the steps of:
(i) at a key generator subsystem: generating a public-private encryption key pair for a device, and transmitting the generated public key to be registered on a blockchain;
(ii) at one or more processors: encrypting a digital asset via the public key of the device, and linking or associating the encrypted digital asset to a non-fungible token (NFT), in which the NFT is associated with a smart contract written on the blockchain; and
(iii) at the device: requesting access to the NFT-linked digital asset; receiving the NFT-linked digital asset when the requirements of the smart contract are met; and decrypting the NFT-linked digital asset using the private key.

### Optional Features:

The device includes the key generator subsystem.
The digital asset is never sent unencrypted in the clear, such as on a cloud or internet.
The NFT-linked digital asset can only be decrypted at the device.
The decrypted digital asset can only be handled, such as reproduced or modified, at the device.
The device cannot send the decrypted digital asset to an external device.
The digital asset is encrypted via an asymmetric cryptography algorithm, such as RSA or ECC.
The private key is never accessible or seen by the end-user of the device.
The private key is stored on a non-transitory storage medium.
The private key cannot be transmitted externally to the device.
The public-private encryption key pair is automatically generated at the first boot or start-up of the device.
The public-private encryption key pair uniquely identifies the device.
The public key of the device is associated with an NFT token on the blockchain.
The public key of the device registered on the blockchain is associated with a digital signature identifying the manufacturer of the device.
The smart contract is configured to execute the requirements for trading the digital asset and is configured to define how the digital asset is managed, owned and/or traded.
Requirements for trading the digital asset include the maximum number of copies of the digital asset.
Smart contract provides an audit trail or log of all the inputs and outputs of each transaction related to the digital asset.
All the inputs and outputs of each transaction related to the digital asset are recorded in real time on the blockchain.
Digital asset is any of the following: artwork, music, image, video, in-game item, file, or firmware code.
The device is implemented in a single System on Chip (SoC).
The decrypted digital asset can be transmitted to peripherals inside the device.
The device is designed using a verified open-source electronic design automation suite.
The device is produced using a verified open-source tool suite.
The method includes the further step of creating chunks or blocks or any other form of batch of the digital asset before encrypting it.
The maximum size of each chunk is determined by the encryption algorithm.
Each chunk is decrypted on the fly at the device.
The device includes a digital wallet subsystem, a storage subsystem and a decryption subsystem.

The corresponding system may be generalised as follows:

A system comprising:
(i) a key generator subsystem, that is configured to generate a public-private encryption key pair for a device, and transmitting the public key to be registered on a blockchain;
(ii) one or more processors configured to encrypt a digital asset via the public key of the device, and link or associate the encrypted digital asset to a non-fungible token (NFT), in which the NFT is associated with a smart contract written on the blockchain;
(iii) the device, in which the device is further configured to: request access to the NFT-linked digital asset; receive the NFT-linked digital asset when the requirements of the smart contract are met; and decrypt the NFT-linked digital asset using its private key.

The corresponding device may be generalised as follows:

A device for securely trading or downloading a digital asset, in which the device includes a key generator subsystem or is connected to a key generator subsystem that is configured to generate a public-private key pair, in which the public key is registered on a blockchain and the private key is stored on a non-transitory storage medium of the device, such that when the device requests a digital asset associated or linked to a smart contract on the blockchain, the digital asset is encrypted by the public key registered on the blockchain and the device is configured to receive the encrypted digital asset and to decrypt the digital asset using its private key.

### B. Trustless Method for Downloading a Digital Asset at a Verified Device Using Two Levels of Encryption

A computer-implemented method, the method including the steps of:
(i) at a key generator subsystem: generating a public-private encryption key pair for a device, and transmitting the generated public key to be registered on a blockchain;
(ii) at one or more processors: generating a symmetric key, encrypting a digital asset via the symmetric key, generating an hybrid key by encrypting the symmetric key using the public key of the device, and linking or associating the encrypted digital asset to a non-fungible token (NFT), in which the NFT is associated with a smart contract written on the blockchain;
(iii) at the device: requesting access to the NFT-linked digital asset; receiving the NFT-linked digital asset and the hybrid key when the requirements of the smart contract are met; and decrypting the hybrid key using the private key and decrypting the NFT-linked digital asset using the symmetric key.

### Optional Features

The device includes the key generator subsystem.
The digital asset is never sent unencrypted in the clear, such as on a cloud or internet.
The NFT-linked digital asset can only be decrypted at the device.
The decrypted digital asset can only be handled, such as reproduced or modified, at the device.
The device cannot send the decrypted digital asset to an external device.
The digital asset is encrypted via a hybrid encryption algorithm.
The private key is never accessible or seen by the end-user of the device.
The private key is stored on a non-transitory storage medium.
The private key cannot be transmitted externally to the device.
The public-private encryption key pair is automatically generated at the first boot or start-up of the device.
The public-private encryption key pair uniquely identifies the device.
The public key of the device is associated with an NFT token on the blockchain.
The public key of the device registered on the blockchain is associated with a digital signature identifying the manufacturer of the device.
The smart contract is configured to execute the requirements for trading the digital asset and is configured to define how the digital asset is managed, owned and/or traded.
Requirements for trading the digital asset include the maximum number of copies of the digital asset.
Smart contract provides an audit trail or log of all the inputs and outputs of each transaction related to the digital asset.
All the inputs and outputs of each transaction related to the digital asset are recorded in real time on the blockchain.
Digital asset is any of the following: artwork, music, image, video, in-game item, file, or firmware code.
The device is implemented in a single System on Chip (SoC).
The decrypted digital asset can be transmitted to peripherals inside the device.
The device is designed using a verified open-source electronic design automation suite.
The device is produced using a verified open-source tool suite.
The method includes the further step of creating chunks or blocks or any other form of batch of the digital asset, before encrypting it.
The maximum size of each chunk is determined by the encryption algorithm.
Each chunk of the digital asset is encrypted via the hybrid key.
Each chunk is decrypted on the fly at the device.
The device includes a digital wallet subsystem, a storage subsystem and a decryption subsystem.

The corresponding system may be generalised as follows:

A system comprising:
(i) a key generator subsystem, that is configured to generate a public-private encryption key pair, and transmit the public key to be registered on a blockchain;
(ii) one or more processors configured to generate a symmetric key, encrypt a digital asset using the symmetric key, generate an hybrid key by encrypting the symmetric key using the public key of the device, and link or associate the encrypted digital asset to a non-fungible token (NFT), in which the NFT is associated with a smart contract written on the blockchain;
(iii) the device, which the device is further configured to: request access to the NFT-linked digital asset; receive the NFT-linked digital asset and the hybrid key when the requirements of the smart contract are met; and decrypt the hybrid key using the private key and decrypt the NFT-linked digital asset using the symmetric key.

The corresponding device may be generalised as follows:

A device for securely trading or downloading a digital asset, in which the device includes a key generator subsystem or is connected to a key generator subsystem that is configured to generate a public-private key pair, in which the public key is registered on a blockchain and the private key is stored on a non-transitory storage medium of the device, such that when the device requests a digital asset connected to a smart contract on the blockchain, the digital asset is encrypted using a symmetric key, and the device is configured to receive the encrypted digital asset and an hybrid key corresponding to the symmetric key encrypted using the public key of the device, to decrypt an hybrid key using its private key and to decrypt the digital asset using the symmetric key.

### C. Specific Blocks or Subsystems of the Verified Device, Such as a SoC or Microcontroller or Microprocessor.

A device comprising the following sub-systems:
(i) a key generator subsystem configured to generate encryption keys, the encryption keys being a public and private key pair;
(ii) a digital wallet subsystem including a first non-transitory storage medium; the digital wallet subsystem configured to store the encryption keys;
(iii) a storage subsystem including a second transitory storage medium, the storage subsystem configured to store an NFT-linked encrypted digital asset;
(iv) a decryption subsystem configured to decrypt the NFT-linked encrypted digital asset; and
(v) a third transitory storage medium configured to store the NFT-linked decrypted digital asset;
in which the public key of the device is registered on a blockchain.

### Optional Features:

a blockchain interface subsystem configured to provide a connection to a blockchain.
the device comprises an encryption subsystem
the device may implement any other features defined above.

### D. A Method for Automatically Registering a Device a Blockchain at First Start-Up

A computer-implemented method, the method including the steps of:
at the first start-up of a key generator subsystem, automatically generating a public-private encryption key pair for a device and transmitting the generated public key to be registered on a blockchain;
associating the public key of the device with an asset token on the blockchain;
and in which the public-private encryption key pair of the device is unique, such that when the device requests to download a digital asset associated with a smart contract written on the blockchain, the digital asset is encrypted and the digital asset can only be decrypted on the device using the private key of the device.

### Optional Features:

The asset token is an NFT token.
The device includes the key generator subsystem.
The digital asset is never sent unencrypted in the clear, such as on a cloud or internet.
The NFT-linked digital asset can only be decrypted at the device.
The decrypted digital asset can only be handled, such as reproduced or modified, at the device.
The device cannot send the decrypted digital asset to an external device.
The digital asset is encrypted via an asymmetric encryption algorithm or a hybrid encryption algorithm.
The private key is never accessible or seen by the end-user of the device.
The private key is stored on a non-transitory storage medium.
The private key cannot be transmitted externally to the device.
The public-private encryption key pair uniquely identifies the device.
The public key of the device is associated with an NFT token on the blockchain.
The public key of the device registered on the blockchain is associated with a digital signature identifying the manufacturer of the device.
The smart contract is configured to execute the requirements for trading the digital asset and is configured to define how the digital asset is managed, owned and/or traded.
Requirements for trading the digital asset include the maximum number of copies of the digital asset.
Smart contract provides an audit trail or log of all the inputs and outputs of each transaction related to the digital asset.
All the inputs and outputs of each transaction related to the digital asset are recorded in real time on the blockchain.
Digital asset is any of the following: artwork, music, image, video, in-game item, file, or firmware code.
The device is implemented in a single System on Chip (SoC).
The decrypted digital asset can be transmitted to peripherals inside the device.
The device is designed using a verified open-source electronic design automation suite.
The device is produced using a verified open-source tool suite.
The method includes the further step of creating chunks or blocks or any other form of batch of the digital asset, before encrypting it.
The maximum size of each chunk is determined by the encryption algorithm.
Each chunk of the digital asset is encrypted via the hybrid key.
Each chunk is decrypted on the fly at the device.
The device includes a digital wallet subsystem, a storage subsystem and a decryption subsystem.

The corresponding system may be generalised as follows:

A system comprising:
(i) a key generator subsystem configured to generate a public-private encryption key pair for a device and to transmit the generated public key to be registered on a blockchain; in which the public-private encryption key pair is generated at the first start up;
(ii) one or more processors configured to associate the public key of the device with an asset token on the blockchain; and
(iii) the device;
and in which the public-private encryption key pair of the device is unique, such that when the device requests to download a digital asset associated with a smart contract written on the blockchain, the digital asset is encrypted and the digital asset can only be decrypted on the device using the private key of the device.

The corresponding device may be generalised as follows:

A device for securely trading or downloading a digital asset, in which the device includes a key generator subsystem or is connected to a key generator subsystem that is configured to generate a public-private key pair, in which the public key is registered or stored on a blockchain and the private key is stored on a non-transitory storage medium of the device, such that when the device requests to download a digital asset associated with a smart contract written on the blockchain, the digital asset is encrypted and the digital asset can only be decrypted on the device using the private key of the device;
and in which the public-private encryption key pair is automatically generated at the first start-up of the device.

### NOTE

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1-58. (canceled)

59. A computer implemented method, the method including the steps of:
(i) at a key generator subsystem: generating a public-private encryption key pair for a device, and transmitting the generated public key to be registered on a blockchain;
(ii) at one or more processors: encrypting a digital asset via the public key of the device, and linking or associating the encrypted digital asset to a non-fungible token (NFT), in which the NFT is associated with a smart contract written on the blockchain; and
(iii) at the device: requesting access to the NFT-linked digital asset; receiving the NFT-linked digital asset when the requirements of the smart contract are met; and decrypting the NFT-linked digital asset using the private key,
wherein the public-private encryption key pair is automatically generated at the first boot or start-up of the device.

60. The method of claim 59, in which the device includes the key generator subsystem.

61. The method of claim 59, in which the digital asset is never sent unencrypted in the clear, such as on a cloud or internet,
in which the NFT-linked digital asset can only be decrypted at the device,
in which the decrypted digital asset can only be handled, such as reproduced or modified, at the device,
in which the device cannot send the decrypted digital asset to an external device.

62. The method of claim 59, in which the digital asset is encrypted via an asymmetric cryptography algorithm, such as RSA or ECC.

63. The method of claim 59, in which the private key is never accessible or seen by the end-user of the device,
in which the private key is stored on a non transitory storage medium, in which the private key cannot be transmitted externally to the device.

64. The method of claim 59, in which the public-private encryption key pair uniquely identifies the device.

65. The method of claim 59, in which the public key of the device is associated with an asset token on the blockchain,
in which the public key registered on the blockchain is associated with a digital signature identifying the device.

66. The method of claim 59, in which the smart contract is configured to execute the requirements for trading the digital asset and is configured to define how the digital asset is managed, owned and/or traded,
in which the requirements for trading the digital asset include the maximum number of copies of the digital asset,
in which the smart contract provides an audit trail or log of all the inputs and outputs of each transaction related to the digital asset,
in which all the inputs and outputs of each transaction related to the digital asset are recorded in real time on the blockchain.

67. The method of claim 59, wherein the digital asset is a firmware code,
wherein the device is implemented in a single System on Chip (SoC),
wherein the method includes the further step of creating chunks or blocks or any other form of batch of the digital asset before encrypting the digital asset,
wherein the encrypted digital asset is stored into a permanent memory of the device, and
wherein each chunk is decrypted and loaded on a RAM of the device on-the-fly at the SoC start up.

68. The method of claim 59, in which the decrypted digital asset can be transmitted to peripherals inside the device.

69. The method of claim 68, in which the maximum size of each chunk is determined by the encryption algorithm.

70. The method of claim 59, in which the device includes a digital wallet subsystem, a storage subsystem and a decryption subsystem.

71. The method of claim 68, in which each chunk of the digital asset is encrypted via the hybrid key.

72. A system comprising:
(i) a key generator subsystem, that is configured to generate a public-private encryption key pair for a device, and transmit the public key to be registered on a blockchain;
(ii) one or more processors configured to encrypt a digital asset via the public key of the device, and link or associate the encrypted digital asset to a non-fungible token (NFT), in which the NFT is associated with a smart contract written on the blockchain; and
(iii) the device, in which the device is further configured to: request access to the NFT-linked digital asset; receive the NFT-linked digital asset when the requirements of the smart contract are met; and decrypt the NFT-linked digital asset using its private key,
in which the public-private encryption key pair is automatically generated at the first boot or start-up of the device.

73. A computer implemented method, the method including the steps of:
(i) at a key generator subsystem: generating a public-private encryption key pair for a device, and transmitting the generated public key to be registered on a blockchain;
(ii) at one or more processors: generating a symmetric key, encrypting a digital asset via the symmetric key, generating a hybrid key by encrypting the symmetric key using the public key of the device, and linking or associating the encrypted digital asset to a non-fungible token (NFT), in which the NFT is associated with a smart contract written on the blockchain; and
(iii) at the device: requesting access to the NFT-linked digital asset; receiving the NFT-linked digital asset and the hybrid key when the requirements of the smart contract are met; and decrypting the hybrid key using the private key and decrypting the NFT-linked digital asset using the symmetric key.
in which the public-private encryption key pair is automatically generated at the first boot or start-up of the device.
